(19) United States
(12) Patent Application Publication
(10) Pub. No.: US 2013/0258053 A1
(43) Pub. Date: Oct. 3, 2013

(54) THREE-DIMENSIONAL VIDEO ENCODING APPARATUS, THREE-DIMENSIONAL VIDEO CAPTURING APPARATUS, AND THREE-DIMENSIONAL VIDEO ENCODING METHOD

(71) Applicant: Panasonic Corporation, Osaka (JP)

(72) Inventors: Yuki MARUYAMA, Osaka (JP); Hideyuki OHGOSE, Osaka (JP); Yuki KOBAYASHI, Osaka (JP); Hiroshi ARAKAWA, Nara (JP); Kiyofumi ABE, Osaka (JP)

(21) Appl. No.: 13/796,779

(22) Filed: Mar. 12, 2013

Related U.S. Application Data
(63) Continuation of application No. PCT/JP2011/005530, filed on Sep. 30, 2011.

(30) Foreign Application Priority Data
Sep. 30, 2010 (JP) 2010-220579

(51) Int. Cl. H04N 13/00

(52) U.S. Cl. CPC H04N 13/0003
USPC 348/43

(57) ABSTRACT

A provided three-dimensional video encoding apparatus adaptively switches a method of setting a reference picture according to a parallax between right and left sides, thereby improving encoding efficiency. A parallax acquisition unit 101 calculates parallax information on a first viewpoint video signal and a second viewpoint video signal according to a parallax matching method or the like. A reference picture setting unit 102 determines, from the parallax information, reference picture setting information on the selection of the reference picture in the encoding of a picture to be encoded, and the allocation of a reference index to the reference picture. An encoding unit 103 compresses and encodes the image data of the picture to be encoded, according to reference picture selection information.

### FIELD OF THE INVENTION

The present invention relates to a three-dimensional video encoding apparatus, a three-dimensional video capturing apparatus, and a three-dimensional video encoding method by which three-dimensional images are compressed and encoded and then are recorded on storage media such as an optical disc, a magnetic disc, and flash memory, and particularly relates to a three-dimensional video encoding apparatus, a three-dimensional video capturing apparatus, and a three-dimensional video encoding method which perform compression and encoding in the H.264 compression encoding format.

### BACKGROUND OF THE INVENTION

As digital video technology has developed, advanced techniques for compression encoding on digital video data have been widely used in response to an increasing data amount. The advanced techniques are embodied as compression encoding techniques specialized for video data to utilize the characteristics of the video data. H.264 compression encoding is expected to be widely used in various fields because it has been also adopted as a moving image compression standard for Blu-ray, a standard for an optical disc, and Advanced Video Codec High Definition (AVCHD), a standard for recording of Hi-Vision images with a video camera.

Generally, in encoding of moving images, the amount of information is compressed by reducing redundancy in a time direction and a spatial direction. In predictive encoding between screens for a reduction in temporal redundancy, an amount of motion (hereinafter, will be called a motion vector) is detected in each block with reference to a preceding or subsequent picture along a time axis, and a prediction (hereinafter, will be called motion compensation) is made in consideration of the detected motion vector to improve prediction accuracy and encoding efficiency. For example, the motion vector of an input image to be encoded is detected, and a predicted residual is encoded between a predicted value shifted by the motion vector and the input image to be encoded, thereby reducing the amount of information required for encoding.

In this case, a picture to be referred to in the detection of the motion vector is called a reference picture. The picture is a term indicating a single screen. The motion vector is detected in each block. Specifically, a block (block to be encoded) on a picture to be encoded is fixed, a block (reference block) on a reference picture is moved in a search range, and then a reference block most similar to the block to be encoded is located to detect a motion vector. The search of the motion vector will be called motion vector detection. Whether a block is similar or not is generally decided by a relative error between a block to be encoded and a reference block. Particularly, a summed absolute difference (SAD) is frequently used. A search through an overall reference picture for a reference block leads to an extremely large computing amount. Thus, a search range is generally limited in a reference picture, and the limited range is called a search range.

When a picture is used for performing only predictive encoding in a screen to reduce spatial redundancy without predictive encoding between screens, the picture is called an I picture. When a picture is used for performing predictive encoding between screens from a reference picture, the picture is called a P picture. When predictive encoding between screens is performed from up to two reference pictures, the picture is called a B picture.

As a three-dimensional video encoding format for encoding the video signal of a first viewpoint (hereinafter, will be called a first viewpoint video signal) and the video signal of a second viewpoint different from the first viewpoint (hereinafter, will be called a second viewpoint video signal), a format for compressing an amount of information by reducing redundancy between viewpoints has been proposed. More specifically, the first viewpoint video signal is encoded in the same format as encoding of a two-dimensional video signal. For the second viewpoint video signal, motion compensation is performed using a reference picture that is a picture of the first viewpoint video signal at the same time as the second viewpoint video signal.

FIG. 13 shows an example of an encoding structure of proposed three-dimensional video encoding. A picture I0, a picture B2, a picture B4, and a picture P6 are pictures included in the first viewpoint video signal while a picture P1, a picture B3, a picture B5, and a picture P7 are pictures included in the second viewpoint video signal. The picture I0 is a picture to be encoded as an I picture. The pictures P1, the picture P6, and the picture P7 are pictures to be encoded as P pictures. The picture B2, the picture B3, the picture B4, and the picture B5 are pictures to be encoded as B pictures. The pictures are displayed in a temporal order. Arrows in FIG. 13 indicate that the picture at the base of the arrow (starting point) may be encoded with reference to the picture at the tip of the arrow (terminal point). The picture P1, the picture B3, the picture B5, and the picture P7 refer to the picture I0, the picture B2, the picture B4, and the picture P6 of the first viewpoint video signal at the same time.

FIG. 14 shows an encoding order for the encoding structure of FIG. 13 and an example of the relationship between pictures to be encoded (hereinafter, will be referred to as encoding target pictures) and the reference pictures used for encoding input pictures. In the case of encoding in the encoding structure of FIG. 13, as shown in FIG. 14, the picture I0, the picture P1, the picture P6, the picture P7, the picture B2, the picture B3, the picture B4, and the picture B5 are encoded in this order.

In this case, motion compensation using, as reference pictures, pictures included in video signals of the same viewpoint will be called intra-view reference, whereas motion compensation using, as reference pictures, pictures included in video signals of different viewpoints will be called inter-view reference. Moreover, the reference pictures for intra-view reference will be called intra-view reference pictures, whereas the reference pictures used for inter-view reference will be called inter-view reference pictures.

One of the first viewpoint video signal and the second viewpoint video signal is a right-eye video signal while the other of the signals is a left-eye video signal. Pictures included in the first viewpoint video signal and pictures included in the second viewpoint video signal at the same time are highly correlated with each other. Thus, intra-view reference or inter-view reference is properly selected in each block, thereby more efficiently reducing an amount of information than in conventional encoding using only intra-view reference.

### DISCLOSURE OF THE INVENTION

In H.264 compression encoding, a reference picture is selected from a plurality of encoded pictures. In the conventional technique, however, a reference picture is selected regardless of variations in parallax. Thus, a reference picture may be selected with low encoding efficiency, resulting in a reduction in encoding efficiency. For example, in the case where parallaxes are widely distributed from the near side to the far side in an input image to be encoded, a so-called occlusion area is expanded that is visible from one viewpoint but is invisible from the other viewpoint. Since image data is not present in an image viewed from the other viewpoint, a point corresponding to a part visible from one viewpoint is made invisible in the occlusion area by matching. Thus, the accuracy for determining a motion vector decreases, resulting in lower encoding efficiency.

The present invention has been devised to solve the problem. An object of the present invention is to provide a video encoding apparatus and a video encoding method which can suppress a reduction in encoding efficiency even in the case of variations in parallax, achieving higher encoding efficiency.

In order to attain the object, a three-dimensional video encoding apparatus of the present invention is a three-dimensional video encoding apparatus that encodes a first viewpoint video signal that is the video signal of a first viewpoint and a second viewpoint video signal that is the video signal of a second viewpoint different from the first viewpoint, the three-dimensional video encoding apparatus including: a parallax acquisition unit that calculates parallax information on a parallax between the first viewpoint video signal and the second viewpoint video signal; a reference picture setting unit that sets a reference picture used for encoding the first viewpoint video signal and the second viewpoint video signal; and an encoding unit that encodes the first viewpoint video signal and the second viewpoint video signal to generate an encoded stream based on the reference picture set in the reference picture setting unit, wherein when the second viewpoint video signal is encoded, the reference picture setting unit has a first setting mode of setting, as a reference picture, at least one of pictures included in the first viewpoint video signal and pictures included in the second viewpoint video signal, and a second setting mode of setting, as a reference picture, at least one of pictures included only in the second viewpoint video signal, and the reference picture setting unit switches the first setting mode and the second setting mode in response to a change of the parallax information obtained in the parallax acquisition unit.

With this configuration, since the reference picture is changed in response to the change of the parallax information, the reference picture with high encoding efficiency can be selected, achieving higher encoding efficiency.

Furthermore, the reference picture setting unit sets, as a reference picture, at least one of pictures included only in the first viewpoint video signal when the second viewpoint video signal is encoded in the first setting mode.

The parallax information is preferably information on variations in parallax vector that indicates a parallax between the first viewpoint video signal and the second viewpoint video signal in one of a pixel and a pixel block containing a plurality of pixels. The reference picture setting unit switches the first setting mode to the second setting mode when the parallax information is large, whereas the reference picture setting unit switches the second setting mode to the first setting mode when the parallax information is small. In this way, the first setting mode is switched to the second setting mode in the case of large variations in parallax vector indicating a parallax between the first viewpoint video signal and the second viewpoint video signal in one of a pixel and a pixel block containing a plurality of pixels. Thus, the first viewpoint video signal, the video signal of the first viewpoint where an occlusion area is expanded, is not selected as a reference picture, thereby improving the accuracy for determining a motion vector with higher encoding efficiency.

Moreover, the parallax information is preferably the variance of the parallax vector, the sum of parallax vector absolute values, and the absolute value of a difference between a maximum parallax and a minimum parallax of the parallax vector.

The parallax information is the variance of the parallax vector and the sum of parallax vector absolute values, allowing variations in parallel vector to be relatively accurately determined with higher reliability.

Furthermore, in the case where the parallax information is the absolute value of a difference between the maximum parallax and the minimum parallax of the parallax vector, a parallax can be determined only from two values, advantageously achieving quite simple calculations for decision with a minimum calculated amount and a minimum processing time.

With this configuration, the reference picture can be switched to a more suitable reference picture, achieving higher encoding efficiency.

Furthermore, the reference picture setting unit is capable of setting at least two reference pictures, and the parallax information is switched so as to change the reference index of the reference picture. In the case where it is decided that the parallax information indicates a large parallax, the reference picture setting unit is capable of allocating a reference index not larger than a currently allocated reference index to the reference picture included in the first viewpoint video signal.

This configuration can minimize the amount of encoding of the reference index, achieving higher encoding efficiency.

A three-dimensional video capturing apparatus of the present invention is a three-dimensional video capturing apparatus that captures an image of a subject from a first viewpoint and a second viewpoint different from the first viewpoint, and captures an image of a first viewpoint video signal that is the video signal of the first viewpoint and an image of a second viewpoint video signal that is the video signal of the second viewpoint, the three-dimensional video capturing apparatus including: a video capturing unit that forms an optical image of the subject, captures the optical image, and obtains the first viewpoint video signal and the second viewpoint video signal as digital signals; a parallax acquisition unit that calculates parallax information on a parallax between the first viewpoint video signal and the second viewpoint video signal; a reference picture setting unit that sets a reference picture used for encoding the first viewpoint video signal and the second viewpoint video signal; an encoding unit that encodes the first viewpoint video signal and the second viewpoint video signal to generate an encoded stream based on the reference picture set in the reference picture setting unit; a recording medium for recording of an output result from the encoding unit; and a setting unit that sets a shooting condition parameter in the video capturing unit, wherein when the second viewpoint video signal is encoded, the reference picture setting unit has a first setting mode of setting, as a reference picture, at least one of pictures included in the first viewpoint video signal and pictures included in the second viewpoint video signal, and a second setting mode of setting, as a reference picture, at least one of pictures included only in the second viewpoint video signal, and the reference picture setting unit switches the first setting mode and the second setting mode in response to one of the shooting condition parameter and a change of the parallax information.

In this case, the shooting condition parameter is preferably an angle formed by the shooting direction of the first viewpoint and the shooting direction of the second viewpoint.

Instead of the angle, the shooting condition parameter may be a distance between one of the first viewpoint and the second viewpoint and the subject.

The three-dimensional video capturing apparatus of the present invention further includes a motion information decision unit that decides whether an image of a video signal contains a large motion or not, wherein a reference picture selected in the first setting mode may be switchable according to motion information. In the case where the motion information decision unit decides that a motion is large, a picture included in the first viewpoint video signal may be set as a reference picture.

A three-dimensional video encoding method of the present invention is a three-dimensional video encoding method of encoding a first viewpoint video signal that is the video signal of a first viewpoint and a second viewpoint video signal that is the video signal of a second viewpoint different from the first viewpoint, wherein when a reference picture used for encoding the second viewpoint video signal is selected from pictures included in the first viewpoint video signal and pictures included in the second viewpoint video signal, the method includes the step of changing the reference picture in response to a change of calculated parallax information.

According to the present invention, the first setting mode of setting, as a reference picture, at least one of pictures included in the first viewpoint video signal and pictures included in the second viewpoint video signal and the second setting mode of setting, as a reference picture, at least one of pictures included only in the second viewpoint video signal are switched in response to a change of the parallax information obtained by the parallax acquisition unit, thereby improving the image quality and encoding efficiency of an encoded stream.

### BRIEF DESCRIPTION OF THE DRAWINGS

FIG. 1 is a block diagram illustrating the configuration of a three-dimensional video encoding apparatus according to a first embodiment;

FIG. 2 is a block diagram illustrating the specific configuration of an encoding unit in the three-dimensional video encoding apparatus according to the first embodiment;

FIG. 3 is a flowchart of operations performed by a reference picture setting unit in the three-dimensional video encoding apparatus according to the first embodiment;

FIG. 4A shows an example of a method of selecting a reference picture determined by the reference picture setting unit and a method of allocating a reference index in the case where it is decided that a parallax is large, in the three-dimensional video encoding apparatus according to the first embodiment;

FIG. 4B shows an example of a method of selecting a reference picture determined by the reference picture setting unit and a method of allocating a reference index in the case where it is decided that a parallax is not large, in the three-dimensional video encoding apparatus according to the first embodiment;

FIG. 5 is a flowchart showing a modification of processing performed by the reference picture setting unit in the three-dimensional video encoding apparatus according to the first embodiment;

FIG. 6 shows an example of an encoding structure for encoding a three-dimensional image;

FIG. 7 is a flowchart showing an example of processing performed by the reference picture setting unit in the three-dimensional video encoding apparatus according to the first embodiment;

FIG. 8A shows an example of a method of allocating a reference index determined by the reference picture setting unit and a method of allocating a reference index in the case where it is decided that a parallax is large, in the three-dimensional video encoding apparatus according to the first embodiment;

FIG. 8B shows an example of a method of allocating a reference index determined by the reference picture setting unit and a method of allocating a reference index in the case where it is decided that a parallax is not large, in the three-dimensional video encoding apparatus according to the first embodiment;

FIG. 9 is a block diagram illustrating the configuration of a three-dimensional video capturing apparatus according to a second embodiment;

FIG. 10 is a block diagram illustrating the configuration of a three-dimensional video encoding apparatus according to the second embodiment;

FIG. 11 is a flowchart showing another modification of a setting operation performed by the reference picture setting unit in a three-dimensional video capturing apparatus according to the first embodiment;

FIG. 12 is a flowchart showing still another modification of the setting operation performed by the reference picture setting unit in the three-dimensional video capturing apparatus according to the first embodiment;

FIG. 13 shows an example of an encoding structure for encoding a three-dimensional image; and

FIG. 14 shows an encoding order for encoding a three-dimensional image and the relationship between pictures to be coded and reference pictures.

### DESCRIPTION OF THE EMBODIMENTS

Embodiments will be described below with reference to the accompanying drawings.

### First Embodiment

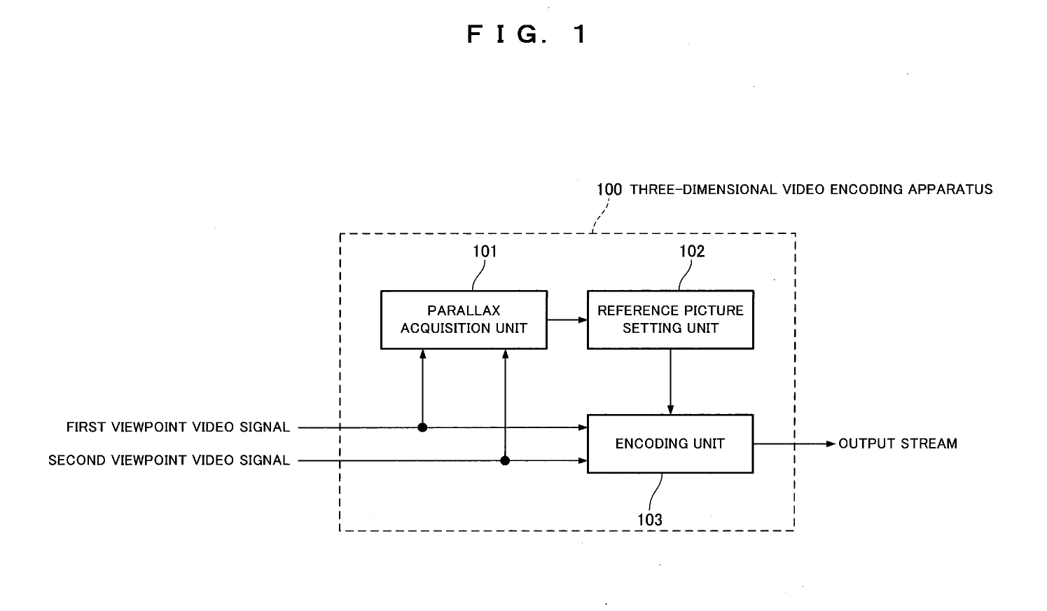

FIG. 1 is a block diagram illustrating the configuration of a three-dimensional video encoding apparatus according to a first embodiment. The three-dimensional video encoding apparatus according to the first embodiment receives a first viewpoint video signal and a second viewpoint video signal and outputs the signals as a stream encoded in the H.264 compression format. In the encoding in the H.264 compression format, a picture is divided into at least one slice. The slice is used as a batch. In the encoding in the H.264 compression format according to the first embodiment, one picture corresponds to one slice, also in second and third embodiments which will be described later.

As illustrated in FIG. 1, a three-dimensional video encoding apparatus 100 includes a parallax acquisition unit 101, a reference picture setting unit 102, and an encoding unit 103.

The parallax acquisition unit 101 calculates parallax information on the first viewpoint video signal and the second viewpoint video signal by a parallax matching method or the like, and outputs the information to the reference picture setting unit 102. The parallax matching method is specifically a stereo matching or block matching method. In another method of obtaining parallax information, the parallax information may be obtained from the outside. The first viewpoint video signal and the second viewpoint video signal are broadcasted on, for example, broadcast waves. At this point, when broadcasted with parallax information being added, the parallax information may be obtained.

The reference picture setting unit 102 sets a reference picture from the parallax information outputted from the parallax acquisition unit 101, the reference picture being referred to during encoding of a picture to be encoded. Furthermore, the reference picture setting unit 102 determines a reference format for allocating a reference index to the set reference picture, based on the parallax information. Thus, the reference picture setting unit 102 changes the reference picture in response to a change of the calculated parallax information. Specifically, when the second viewpoint video signal is encoded, the reference picture setting unit 102 has a first setting mode of setting, as a reference picture, at least one of pictures included in the first viewpoint video signal and pictures included in the second viewpoint video signal, and a second setting mode of setting, as a reference picture, at least one of pictures included only in the second viewpoint video signal. The first setting mode and the second setting mode are switched in response to a change of the parallax information obtained in the parallax acquisition unit 101. The reference picture setting unit 102 then outputs the determined information (hereinafter, will be called reference picture setting information) to the encoding unit 103. The specific operations of the reference picture setting unit 102 will be described later.

The encoding unit 103 performs a series of encoding operations including motion vector detection, motion compensation, intra-picture prediction, orthogonal transformation, quantization, and entropy encoding based on the reference picture setting information determined in the reference picture setting unit 102. In the first embodiment, the encoding unit 103 compresses and encodes image data on a picture to be encoded, by encoding in the H.264 compression format based on the reference picture setting information outputted from the reference picture setting unit 102.

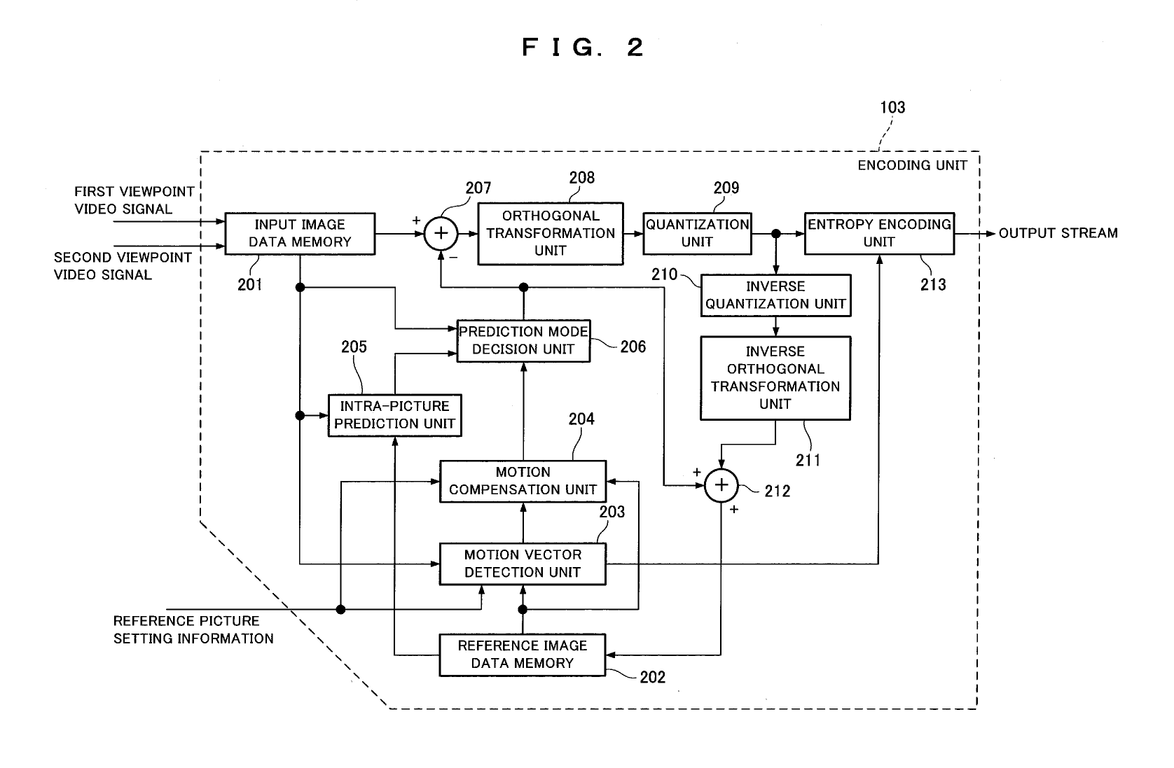

Referring to FIG. 2, the specific configuration of the encoding unit 103 will be described below. FIG. 2 is a block diagram illustrating the specific configuration of the encoding unit 103 in the three-dimensional video encoding apparatus 100 according to the first embodiment.

As illustrated in FIG. 2, the encoding unit 103 includes an input image data memory 201, a reference image data memory 202, a motion vector detection unit 203, a motion compensation unit 204, an intra-picture prediction unit 205, a prediction mode decision unit 206, a difference calculation unit 207, an orthogonal transformation unit 208, a quantization unit 209, an inverse quantization unit 210, an inverse orthogonal transformation unit 211, an addition unit 212, and an entropy encoding unit 213.

The input image data memory 201 contains image data on the first viewpoint video signal and the second viewpoint video signal. The intra-picture prediction unit 205, the motion vector detection unit 203, the prediction mode decision unit 206, and the difference calculation unit 207 refer to information stored in the input image data memory 201.

The reference image data memory 202 contains local decoded images.

The motion vector detection unit 203 searches the local decoded images stored in the reference image data memory 202, detects an image area closest to an input image according to the reference picture setting information inputted from the reference picture setting unit 102, and determines a motion vector indicating the position of the image area. Moreover, the motion vector detection unit 203 determines the size of a block to be encoded with a minimum error and a motion vector for the size, and transmits the determined information to the motion compensation unit 204 and the entropy encoding unit 213.

The motion compensation unit 204 extracts an image area most suitable for a prediction image from the local decoded images stored in the reference image data memory 202, according to the motion vector included in the information received from the motion vector detection unit 203 and the reference picture setting information inputted from the reference picture setting unit 102. The motion compensation unit 204 then generates a prediction image for inter-picture prediction and outputs the generated prediction image to the prediction mode decision unit 206.

The intra-picture prediction unit 205 performs intra-picture prediction using encoded pixels in the same screen from the local decoded images stored in the reference image data memory 202, generates a prediction image for intra-picture prediction, and then outputs the generated prediction image to the prediction mode decision unit 206.

The prediction mode decision unit 206 decides a prediction mode, switches the prediction image generated for the intra-picture prediction from the intra-picture prediction unit 205 and the prediction image generated for the inter-picture prediction from the motion compensation unit 204, and outputs the prediction image according to the decision result. The prediction mode is decided in the prediction mode decision unit 206 as follows: for example, the summed absolute difference of the pixels of the input image and the prediction image is determined for inter-picture prediction and intra-picture prediction, and then the prediction with a smaller value is identified as a prediction mode.

The difference calculation unit 207 obtains image data to be encoded, from the input image data memory 201, calculates a pixel difference value between the obtained input image and the prediction image outputted from the prediction mode decision unit 206, and outputs the calculated pixel difference value to the orthogonal transformation unit 208.

The orthogonal transformation unit 208 transforms the pixel difference value inputted from the difference calculation unit 207 to a frequency coefficient, and then outputs the transformed frequency coefficient to the quantization unit 209.

The quantization unit 209 quantizes the frequency coefficient inputted from the orthogonal transformation unit 208, and outputs the quantized value, that is, a quantization value as encoded data to the entropy encoding unit 213 and the inverse quantization unit 210.

The inverse quantization unit 210 inversely quantizes the quantized value inputted from the quantization unit 209 so as to restore the value into the frequency coefficient, and then outputs the restored frequency coefficient to the inverse orthogonal transformation unit 211.

The inverse orthogonal transformation unit 211 inversely frequency-converts the frequency coefficient inputted from the inverse quantization unit 210 into a pixel difference value, and then outputs the inversely frequency-converted pixel difference value to the addition unit 212.

The addition unit 212 adds the pixel difference value inputted from the inverse orthogonal transformation unit 211 and the prediction image outputted from the prediction mode decision unit 206 into a local decoded image, and then outputs the local decoded image to the reference image data memory 202. The local decoded image stored in the reference image data memory 202 is basically identical to the input image stored in the input image data memory 201 but contains strain components such as quantizing distortion, because the local decoded image temporarily undergoes orthogonal transformation and quantization in the orthogonal transformation unit 208, the quantization unit 209, and so on, and then undergoes inverse quantization and inverse orthogonal transformation in the inverse quantization unit 210, the inverse orthogonal transformation unit 211, and so on.

The reference image data memory 202 contains the local decoded image inputted from the addition unit 212.

The entropy encoding unit 213 performs entropy encoding on the quantized value inputted from the quantization unit 209 and the motion vector or the like inputted from the motion vector detection unit 203, and outputs the encoded data as an output stream.

Processing performed by the three-dimensional video encoding apparatus 100 configured thus will be described below.

First, the first viewpoint video signal and the second viewpoint video signal are inputted to the parallax acquisition unit 101 and the encoding unit 103, respectively. The first viewpoint video signal and the second viewpoint video signal with, for example, 1920×1080 pixels are stored in the input image data memory 201 of the encoding unit 103.

The parallax acquisition unit 101 then calculates parallax information on the first viewpoint video signal and the second viewpoint video signal according to the parallax matching method or the like, and then outputs the parallax information to the reference picture setting unit 102. In this case, the calculated parallax information is, for example, information on a parallax vector (hereinafter, will be called a depth map) representing a parallax for each pixel or pixel block of the first viewpoint video signal and the second viewpoint video signal.

The reference picture setting unit 102 then determines a reference format for setting a reference picture and allocating a reference index to the reference picture when a picture to be encoded is encoded in an encoding mode from the parallax information outputted from the parallax acquisition unit 101, and then the reference picture setting unit 102 outputs the reference format as reference picture setting information to the encoding unit 103. When the first viewpoint video signal is encoded, a reference picture to be used is set from first reference pictures included in the first viewpoint video signal.

When the second viewpoint video signal is encoded, a reference picture to be used is set from second viewpoint inter-view reference pictures included in the first viewpoint video signal and second viewpoint intra-view reference pictures included in the second viewpoint video signal. When the second viewpoint video signal is encoded, a reference picture is set according to a change of the parallax information outputted from the parallax acquisition unit 101; meanwhile, switching is performed between the first setting mode of setting, as a reference picture, at least one of the second viewpoint inter-view reference pictures included in the first viewpoint video signal and the second viewpoint intra-view reference pictures included in the second viewpoint video signal and the second setting mode of setting, as a reference picture, at least one of pictures included only in the second viewpoint video signal. In other words, the reference picture is changed in response to a change of the calculated parallax information.

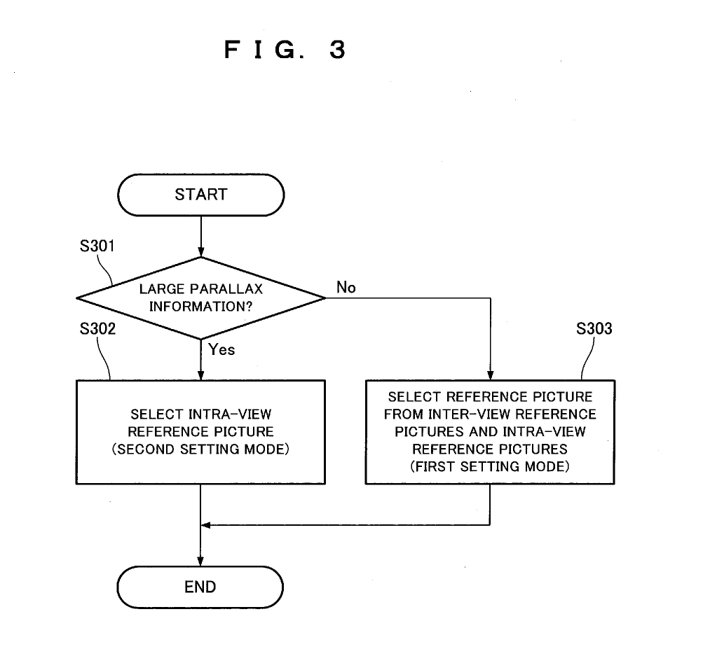

When the second viewpoint video signal is encoded, an encoding structure set by the reference picture setting unit 102 is determined based on the parallax information obtained in the parallax acquisition unit 101. The process of determination will be described below. FIG. 3 is a flowchart of operations performed by the reference picture setting unit 102 based on the parallax information.

In FIG. 3, when the second viewpoint video signal is encoded, the reference picture setting unit 102 decides whether the parallax information on a parallax between the first viewpoint video signal and the second viewpoint video signal is large or not by using the parallax information inputted from the parallax acquisition unit 101 (step S301). In the case where it is decided in step S301 that the parallax information is large (Yes in step S301), the reference picture setting unit 102 selects a reference picture from intra-view reference pictures included in the second viewpoint video signal (step S302: the second setting mode). In the case where it is decided in step S301 that the parallax information is not large (No in step S301), the reference picture setting unit 102 selects a reference picture from inter-view reference pictures included in the first viewpoint video signal and intra-view reference pictures included in the second viewpoint video signal (step S303: first setting mode).

In this case, whether the parallax information is large or not is decided by the presence or absence of variations in parallax vector among pixels or pixel blocks of the first viewpoint video signal and the second viewpoint video signal. Specifically, the decision method may depend upon, for example, whether the variance of the depth map is at least a threshold value or not. The determination of the variance of the depth map makes it possible to decide whether the parallax information is large or not by the presence or absence of variations in parallax vector among pixels or pixel blocks. For example, the presence or absence of variations in parallax vector among pixels or pixel blocks may be decided depending upon whether the sum of the absolute values of parallax vectors in the depth map is at least the threshold value or not. Moreover, whether the parallax information is large or not may be decided by the presence or absence of variations in parallax vector among pixels or pixel blocks according to statistical information other than variances. For example, statistical processing may be performed using the histogram of the depth map. Furthermore, whether the parallax information is large or not may be decided by the presence or absence of variations in parallax vector among pixels or pixel blocks according to a maximum parallax and a minimum parallax that are obtained from the depth map. The maximum parallax and the minimum parallax include positive and negative values. In this case, the presence or absence of variations in parallax vector among pixels or pixel blocks may be decided as follows: a feature quantity is set at the absolute value of a difference between the maximum parallax and the minimum parallax of the parallax vector, that is, the sum of the absolute values of the maximum parallax and the minimum parallax (the maximum parallax is positive and the minimum parallax is negative) or the absolute value of a difference between the maximum parallax and the minimum parallax (the maximum parallax and the minimum parallax are both positive or negative), and then the presence or absence of variations in parallax vector among pixels or pixel blocks is decided depending upon whether or not the feature quantity is at least a threshold value that is an absolute difference value for decision. A decision on the parallax information is made based on the variance of a parallax vector or the sum of the absolute values of parallax vectors, advantageously achieving a relatively correct decision on variations in parallax vector with higher reliability. Moreover, it is decided that a parallax is large in the case where the absolute value of a difference between the maximum parallax and the minimum parallax is at least the predetermined absolute difference value for decision. Thus, whether a parallax is large or not can be decided only by two values, advantageously achieving quite simple calculations for decision with a minimum calculated amount and a minimum processing time as compared with the determination of a variance.

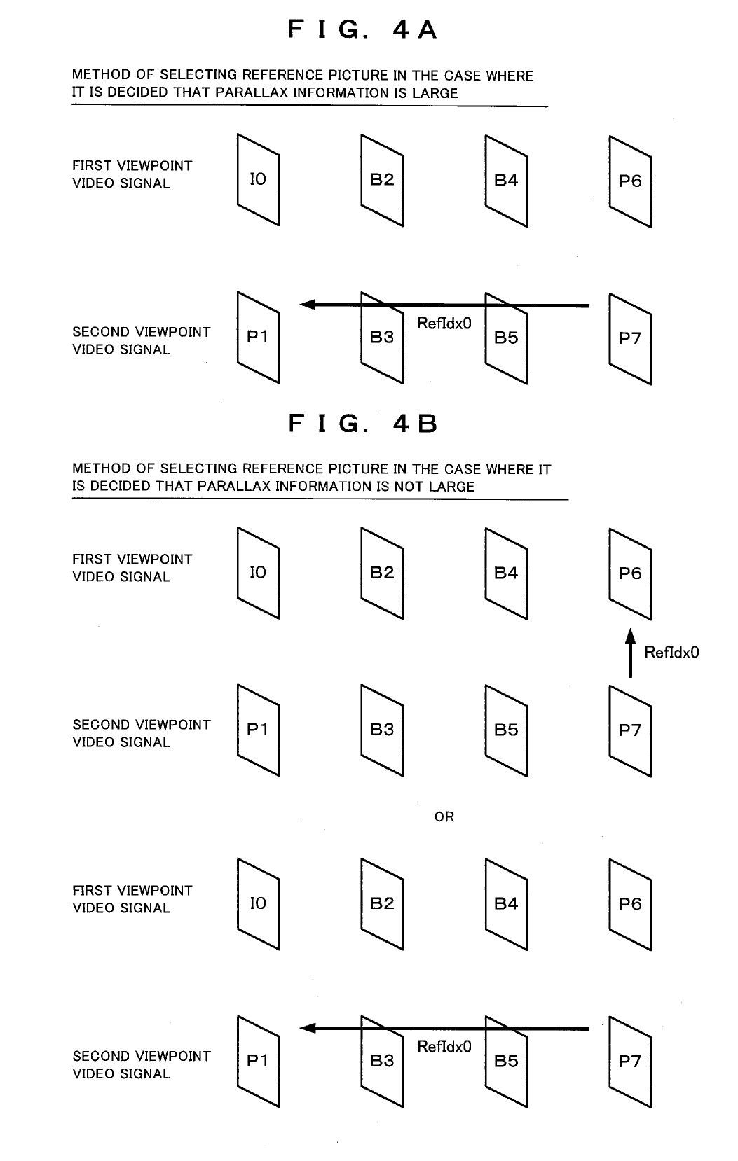

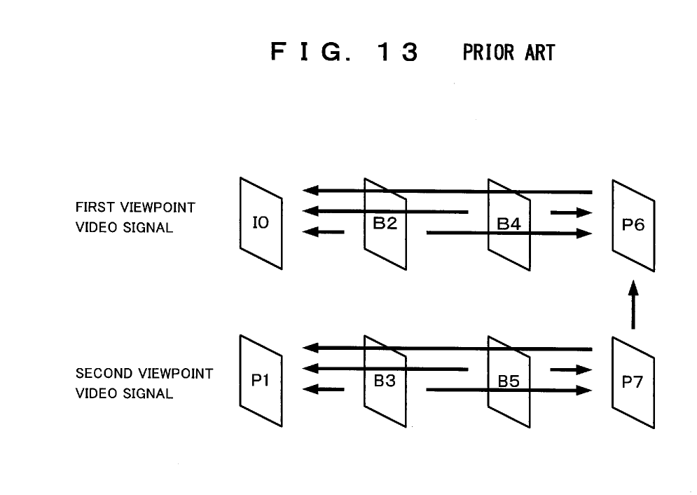

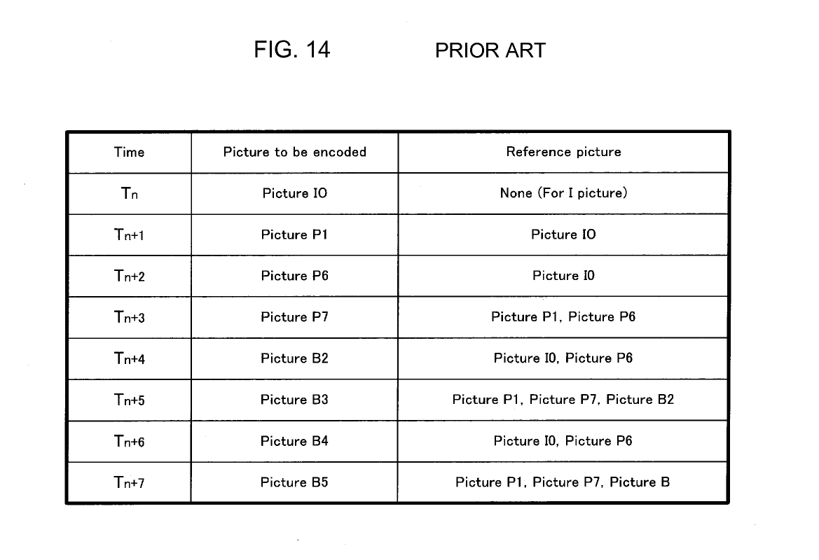

Referring to FIGS. 4A and 4B, the determination of the reference picture setting information by the reference picture setting unit 102 will be specifically described below. FIGS. 4A and 4B show a method of selecting a reference picture by the reference picture setting unit 102 when it is decided that a parallax is large (FIG. 4A) and a method of selecting a reference picture by the reference picture setting unit 102 when it is decided that a parallax is not large (FIG. 4B). In this case, the reference picture is selected and encoded as a P picture. The meanings of arrows in FIGS. 4A and 4B are similar to those of FIG. 13.

In this case, a target picture P7 is encoded as a P picture. In the case where it is decided that parallax information is large, a reference picture is selected as follows: for example, as shown in FIG. 4A, the picture P7 selects, as a reference picture, a picture P1 that is an intra-view reference picture included in the second viewpoint video signal (second setting mode). In the case where it is decided that a parallax is not large, a reference picture is selected as follows: for example, as shown in FIG. 4B, the picture P7 selects, as a reference picture, a picture P6 that is an inter-view reference picture included in the first viewpoint video signal or the picture P1 that is an intra-view reference picture included in the second viewpoint video signal (first setting mode). The reference picture is changed in response to a change of the calculated parallax information.

According to this method, a data amount required for encoding can be reduced as compared with encoding performed using a plurality of reference pictures while keeping the detection accuracy of a motion vector. Thus, the circuit area can be reduced with maintained encoding efficiency. When the parallax information indicating variations in parallax vector is large, switching to the second setting mode does not allow the selection of the first viewpoint video signal that is a video signal of a first viewpoint with an expanded occlusion area as a reference picture, thereby improving the detection accuracy of a motion vector with higher encoding efficiency.

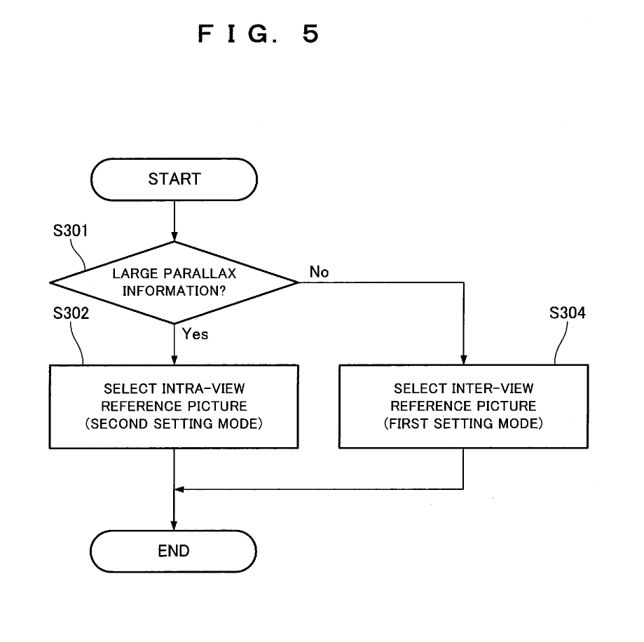

In the present embodiment, when it is decided that the parallax information is not large, a reference picture is selected from inter-view reference pictures included in the first viewpoint video signal and inter-view reference pictures included in the second viewpoint video signal (first setting mode). The selection of a reference picture is not particularly limited. Specifically, as shown in step S304 of FIG. 5, when it is decided that the parallax information is not large in the first setting mode, a reference picture may be selected from intra-view reference pictures included in the second viewpoint video signal. Also in this configuration, when it is decided that a parallax is large, the reference picture setting unit 102 in the second setting mode does not select a reference picture from inter-view reference pictures included in the first viewpoint video signal, thereby suppressing a calculated amount while contributing to a reduction in power as compared with the case where a reference picture can be selected from intra-view reference pictures included in the second viewpoint video signal and inter-view reference pictures included in the first viewpoint video signal.

In the case of the encoding format, the encoding efficiency may decrease depending upon the allocation of a reference index. Specifically, in H.264 compression encoding, a reference picture can be selected from a plurality of encoded pictures. Selected reference pictures are managed by variables called reference indexes. When a motion vector is encoded, the reference index is simultaneously encoded as information on the reference picture of the motion vector. The reference index has a value of at least 0. The smaller the value, the smaller the amount of encoded information. The allocation of reference indexes to reference pictures can be optionally set. Thus, the encoding efficiency can be improved by allocating small-number reference indexes to reference pictures having a large number of reference motion vectors.

For example, in context-based adaptive binary arithmetic coding (CABAC) that is a kind of arithmetic coding adopted for the H.264 compression encoding format, data to be encoded is binarized and is arithmetically encoded. Thus, a reference index is also binarized and arithmetically encoded. In this case, the reference index of “2” has a code length (binary signal length) of 3 bits after binarization, whereas the reference index of “1” has a binary signal length of 2 bits. The reference index of “0” has a code length (binary signal length) of 1 bit after binarization. The smaller the value of the reference index, the shorter the binary signal length. Thus, the smaller the value of the reference index, the smaller the final encoding amount obtained by encoding the reference index.

in the case where the allocation of the reference index is not set for encoding, default allocation defined by the H.264 standard is adopted. In a default allocation method of reference indexes, a small-number reference index is allocated to an intra-view reference picture, and a reference index allocated to an inter-view reference picture is larger than the reference index allocated to the intra-view reference picture.

In the case where a picture to be encoded and an inter-view reference picture are less correlated with each other, the default allocation method of reference indexes is desirable. This is because a picture to be encoded is highly correlated with an intra-view reference picture as compared with an inter-view reference picture, and motion vectors referring to intra-view reference pictures are frequently detected.

In the case where a picture to be encoded and an inter-view reference picture are highly correlated with each other, the correlation of the inter-view reference picture is higher than that of an intra-view reference picture, allowing motion vectors referring to inter-view reference pictures to be frequently detected.

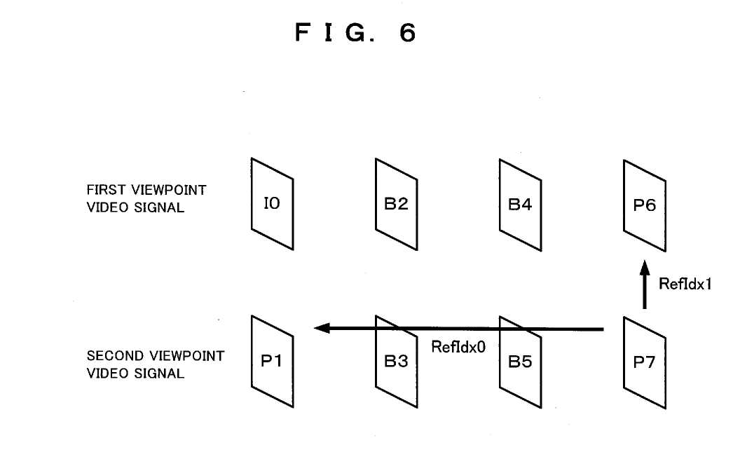

For example, in the case where the target picture P7 is encoded as the P picture as shown in FIG. 6, high correlation between the target picture P7 and the inter-view reference picture P6 allows a motion vector referring to the inter-view reference picture P6 with an allocated reference index 1 (Refldx1 in FIG. 6) to be more frequently selected than a motion vector referring to the intra-view reference picture P1 with an allocated reference index 0 (Refldx0 in FIG. 6). Hence, in the default allocation method of reference indexes, high correlation between a picture to be encoded and an inter-view reference picture leads to lower encoding efficiency.

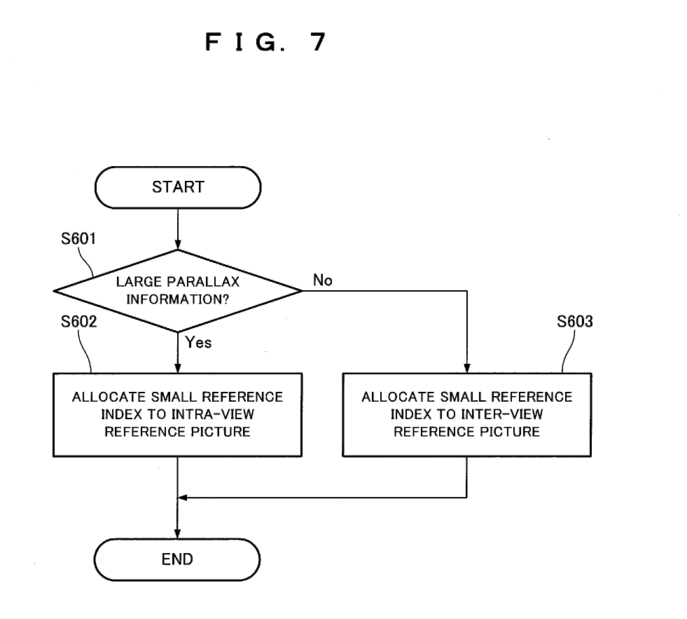

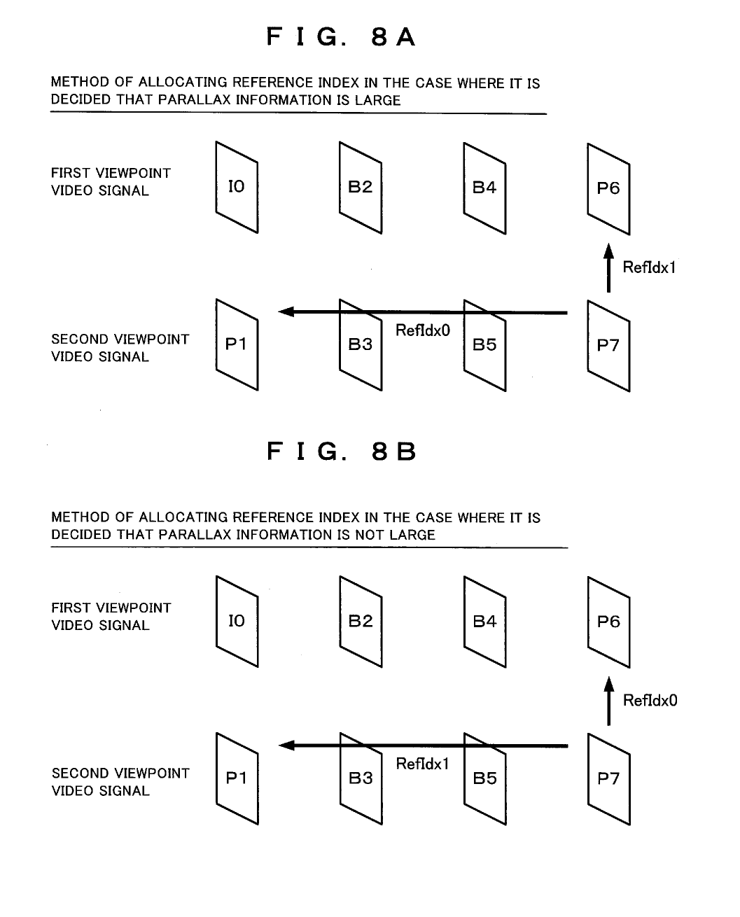

Thus, the allocation method of reference indexes needs to be properly set by using the following method. Referring to FIGS. 7, 8A, and 8B, operations of a reference index allocation method performed by the reference picture setting unit 102 will be described below. FIG. 7 is a flowchart showing an example of the reference index allocation method performed in an encoding mode by the reference picture setting unit 102.

In FIG. 7, the reference picture setting unit 102 decides whether parallax information inputted from the parallax acquisition unit 101 is large or not (step S601). In the case where it is decided in step S601 that the parallax information is large (Yes in step S601), the reference picture setting unit 102 allocates a small reference index to a second viewpoint intra-view reference picture (hereinafter, will be abbreviated as an intra-view reference picture) (step S602). In the case where it is decided in step S601 that the parallax information is not large (equal or smaller) (No in step S601), the reference picture setting unit 102 allocates a small reference index to a second viewpoint inter-view reference picture (hereinafter, will be abbreviated as an inter-view reference picture) (step S603).

Referring to FIGS. 8A and 8B, a specific example will be described below. FIGS. 8A and 85 show a reference index allocation method in the case where it is decided that a parallax is large (FIG. 8A), and a reference index allocation method in the case where it is decided that a parallax is not large (FIG. 8B). A picture to be encoded is encoded as a P picture. The meanings of arrows in FIGS. 8A and 8B are similar to those of FIG. 13.

The picture to be encoded is denoted as P7 and is encoded as the P picture in the following explanation. In the case where it is decided that a parallax is large in the reference index allocation method, for example, as shown in FIG. 8A, the picture P7 selects a reference picture for a motion vector from a picture P1 and a picture P6, and the reference index 0 is allocated to the picture P1 while the reference index 1 is allocated to the picture P6. When it is decided that a parallax is not large in the reference index allocation method, for example, as shown in FIG. 8B, the picture P7 selects a reference picture for a motion vector from the picture P1 and the picture P6, and the reference index 1 is allocated to the picture P1 while the reference index 0 is allocated to the picture P6.

As has been discussed, a reference picture is set such that a small-number reference index is allocated to an intra-view reference picture when it is decided that parallax information on the first viewpoint video signal and the second viewpoint video signal is large, whereas a small-number reference index is allocated to an inter-view reference picture when it is decided that parallax information on the first viewpoint video signal and the second viewpoint video signal is not large.

In other words, the reference picture setting unit 102 can change the allocation of reference indexes in the encoding mode depending upon the parallax information. Thus, in the case where it is decided that the parallax information is large, a reference index not larger than a currently allocated reference index can be allocated to an intra-view reference picture (for example, when the currently allocated reference index is 1, the reference index is changeable to 0, whereas when the currently allocated reference index is 0, the reference index is kept at 0). When the reference index allocated to the intra-view reference picture is changed, a reference index not smaller than the currently allocated reference index can be allocated to an inter-view reference picture (for example, when the currently allocated reference index is 0, the reference index is changeable to 1, whereas when the currently allocated reference index is 1, the reference index is kept at 1). In the case where it is decided that the parallax information is not large, a reference index not larger than the currently allocated reference index can be allocated to an inter-view reference picture (for example, when the currently allocated reference index is 1, the reference index is changeable to 0, whereas when the currently allocated reference index is 0, the reference index is kept at 0). When the reference index allocated to the inter-view reference picture is changed, a reference index not smaller than the currently allocated reference index can be allocated to an intra-view reference picture (for example, when the currently allocated reference index is 0, the reference index is changeable to 1, whereas when the currently allocated reference index is 1, the reference index is kept at 1).

Thus, the reference index of the reference picture with multiple motion vectors referring to the picture can be set at a small value, improving encoding efficiency. Consequently, higher image quality and encoding efficiency can be obtained.

### Second Embodiment

The present invention can be realized as an imaging apparatus, e.g., a stereoscopic camera. A second embodiment will describe processing performed by a three-dimensional video capturing apparatus provided with a three-dimensional video encoding apparatus.

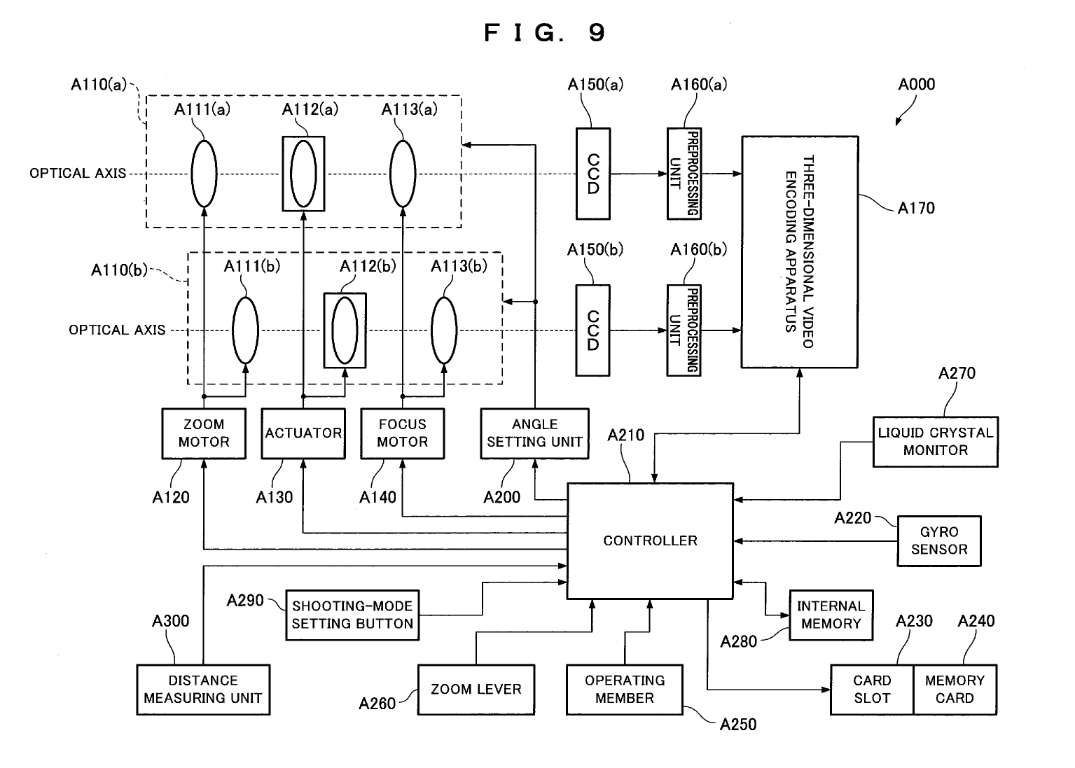

FIG. 9 is a block diagram illustrating the configuration of the three-dimensional video capturing apparatus according to the second embodiment.

As illustrated in FIG. 9, a three-dimensional video capturing apparatus A000 includes optical systems A110(a) and A110(b), a zoom motor A120, a blur-correcting actuator A130, a focus motor A140, CCD image sensors A150(a) and A150(b), preprocessing units A160(a) and A160(b), a three-dimensional video encoding apparatus A170, an angle setting unit A200, a controller A210, a gyro sensor A220, a card slot A230, a memory card A240, an operating member A250, a zoom lever A260, a liquid crystal monitor A270, an internal memory A280, a shooting-mode setting button A290, and a distance measuring unit A300.

The optical system A110(a) includes a zoom lens A111(a), an optical blur-correcting mechanism A112(a), and a focus lens A113(a). The optical system A110(b) includes a zoom lens A111(b), an optical blur-correcting mechanism A112(b), and a focus lens A113(b).

Specifically, the optical blur-correcting mechanisms A112(a) and A112(b) may be blur-correcting mechanisms known as optical image stabilizers (OISs). In this case, the actuator A130 is an OIS actuator.

The optical system A110(a) forms a subject image from a first viewpoint. The optical system A110(b) forms a subject image from a second viewpoint that is different from the first viewpoint.

The zoom lenses A111(a) and A111(b) move along the optical axis of the optical system, allowing scaling of a subject image. The zoom lenses A111(a) and A111(b) are driven under the control of the zoom motor A120.

The optical blur-correcting mechanisms A112(a) and A112(b) each contain a correcting lens movable in a plane orthogonal to the optical axis. The optical blur-correcting mechanisms A112(a) and A112(b) drive the correcting lenses in a direction in which a blur of the three-dimensional video capturing apparatus A100 is offset, thereby reducing a blur of the subject image. Each of the correcting lenses in the optical blur-correcting mechanisms A112(a) and A112(b) can be moved from the center by up to a distance L. The optical blur-correcting mechanisms A112(a) and A112(b) are driven under the control of the actuator A130.

The focus lenses A113(a) and A113(b) move along the optical axis of the optical system to adjust a subject image into focus. The focus lenses A113(a) and A113(b) are driven under the control of the focus motor A140.

The zoom motor A120 drives and controls the zoom lenses A111(a) and A111(b). The zoom motor A120 may be realized by a pulse motor, a DC motor, a linear motor, a servo motor, and so on. The zoom motor A120 may drive the zoom lenses A111(a) and A111(b) via mechanisms such as a cam mechanism and a ball screw. Moreover, the zoom lenses A111(a) and A111(b) may be controlled by the same operations.

The actuator A130 drives and controls the correcting lenses in the optical blur-correcting mechanisms A112(a) and A112(b), in the plane orthogonal to the optical axis. The actuator A130 can be realized by a planar coil and an ultrasonic motor.

The focus motor A140 drives and controls the focus lenses A113(a) and A113(b). The focus motor A140 may be realized by a pulse motor, a DC motor, a linear motor, a servo motor, and so on. The focus motor A140 may drive the focus lenses A113(a) and A113(b) via mechanisms such as a cam mechanism and a ball screw.

The CCD image sensors A150(a) and A150(b) capture subject images formed by the optical systems A110(a) and A110(b) and generate a first viewpoint video signal and a second viewpoint video signal. The CCD image sensors A150(a) and A150(b) perform various operations of exposure, transfer, an electronic shutter, and so on.

The preprocessing units A160(a) and A160(b) perform kinds of processing on the first viewpoint video signal and the second viewpoint video signal that are generated by the CCD image sensors A150(a) and A150(b). For example, the preprocessing units A160(a) and A160(b) perform kinds of video correction, e.g., gamma correction, white balance correction, and scratch correction on the first viewpoint video signal and the second viewpoint video signal.

The three-dimensional video encoding apparatus A170 compresses the first viewpoint video signal and the second viewpoint video signal that have undergone video correction in the preprocessing units A160(a) and A160(b), according to a compression format compliant with the H.264 compression encoding format. An encoded stream obtained by the compression and encoding is recorded on the memory card A240.

The angle setting unit A200 controls the optical system A110(a) and the optical system A110(b) to adjust an angle formed by the optical axes of the optical system A110(a) and the optical system A110(b).

The controller A210 is a control unit for controlling the overall apparatus. The controller A210 can be realized by a semiconductor element and so on. The controller A210 may only include hardware or a combination of hardware and software. Alternatively, the controller A210 may be realized by a microcomputer and so on.

The gyro sensor A220 includes a vibrating member, e.g., a piezoelectric element. The gyro sensor A220 vibrates the vibrating member, e.g., a piezoelectric element at a constant frequency and converts a force from a Coriolis force into a voltage to obtain angular velocity information. The angular velocity information is obtained from the gyro sensor A220, and the correcting lenses in the OISs are driven in a direction in which the vibrations are offset, thereby correcting vibrations applied by a user to the three-dimensional video capturing apparatus A000.

The memory card A240 can be inserted and removed to and from the card slot A230. The card slot A230 can be mechanically and electrically connected to the memory card A240.

The memory card A240 contains a flash memory or a ferroelectric memory capable of storing data.

The operating member A250 is provided with a release button. The release button receives a pressing operation of the user. When the release button is pressed halfway down, auto focus (AF) control and auto exposure (AE) control are started through the controller A210. When the release button is fully pressed, an image of a subject is captured.

The zoom lever A260 is a member that receives an instruction of changing a zooming magnification from the user.

The liquid crystal monitor A270 is a display device capable of providing 2D display or 3D display of the first viewpoint video signal or the second viewpoint video signal that is generated by the CCD image sensors A150(a) and A150(b) or the first viewpoint video signal and the second viewpoint video signal that are read from the memory card A240. Furthermore, the liquid crystal monitor A270 can display various kinds of setting information of the three-dimensional video capturing apparatus A000. For example, the liquid crystal monitor A270 can display shooting conditions such as an EV value, an F value, a shutter speed, and ISO sensitivity.

The internal memory A280 contains control programs for controlling the overall three-dimensional video capturing apparatus A000. Moreover, the internal memory A280 acts as a work memory of the three-dimensional video encoding apparatus A170 and the controller A210. Furthermore, the internal memory A280 temporarily stores the shooting conditions of the optical systems A110(a) and A110(b) and the CCD image sensors A150(a) and A150(b) at the time of shooting. The shooting conditions include a subject distance, field angle information, ISO sensitivity, a shutter speed, an EV value, an F value, a distance between lenses, a time of shooting, an OIS shift amount, and an angle formed by the optical axes of the optical system A110(a) and the optical system A110(b).

The mode setting button A290 is a button for setting a shooting mode when an image is captured by the three-dimensional video capturing apparatus A000. “Shooting mode” shows a shooting scene estimated by the user. For example, 2D shooting modes including (1) portrait mode, (2) child mode, (3) pet mode, (4) macro mode, and (5) landscape mode, and (6) 3D shooting mode are available. A 3D shooting mode may be provided for (1) to (5). The three-dimensional video capturing apparatus A000 sets a proper shooting parameter based on the shooting mode to capture an image. The shooting modes may include a camera automatic setting mode that allows automatic setting of the three-dimensional video capturing apparatus A000. The shooting-mode setting button A290 is a button for setting a playback mode for a video signal recorded on the memory card A240.

The distance measuring unit A300 has the function of measuring a distance from the three-dimensional video capturing apparatus A000 to a subject to be imaged. The distance measuring unit A300 emits, for example, an infrared signal and then measures the reflected signal of the emitted infrared signal, allowing distance measurement. A distance measurement method by the distance measuring unit A300 may be any general method but is not limited to the foregoing method.

Processing performed by the three-dimensional video capturing apparatus A000 configured thus will be described below.

First, in the case where the shooting-mode setting button A290 is operated by a user, the three-dimensional video capturing apparatus A000 obtains a shooting mode after the operation.

The controller A210 goes on standby until the release button is fully pressed.

When the release button is fully pressed, the CCD image sensors A150(a) and A150(b) capture images under the shooting conditions set by the shooting mode and generate the first viewpoint video signal and the second viewpoint video signal.

When the first viewpoint video signal and the second viewpoint video signal are generated, the preprocessing units A160(a) and A160(b) perform various kinds of picture processing on the generated two video signals according to the shooting mode.

After the picture processing in the preprocessing units A160(a) and A160(b), the three-dimensional video encoding apparatus A170 compresses and encodes the first viewpoint video signal and the second viewpoint video signal into an encoded stream.

The generated encoded stream is recorded by the controller A210 on the memory card A240 connected to the card slot A230.

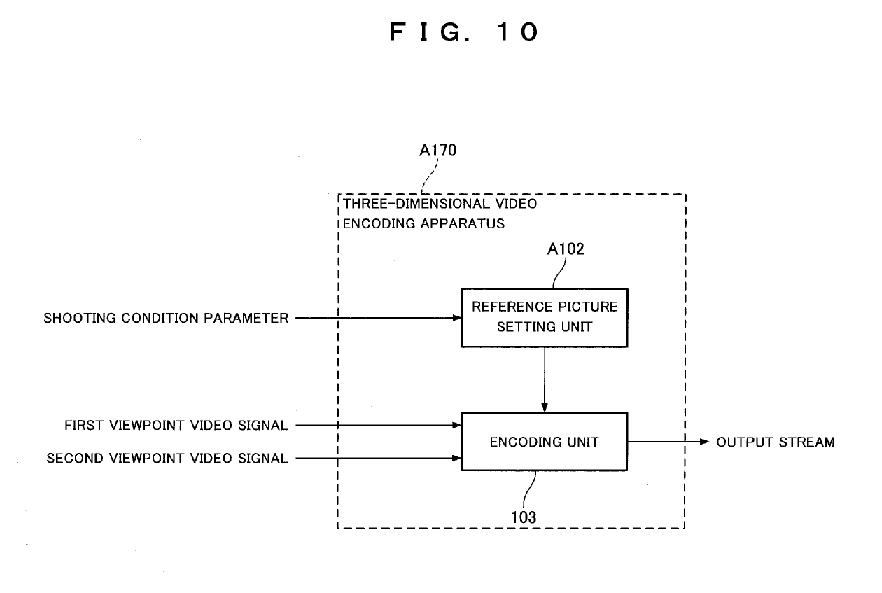

Referring to FIG. 10, the configuration of the three-dimensional video encoding apparatus A170 will be described below. FIG. 10 is a block diagram illustrating the configuration of the three-dimensional video encoding apparatus A170 according to the second embodiment.

In FIG. 10, the three-dimensional video encoding apparatus A170 includes a reference picture setting unit A102 and an encoding unit 103.

The reference picture setting unit A102 determines a reference format, e.g., the setting of a reference picture to be encoded and the allocation of a reference index to the reference picture based on shooting condition parameters such as a subject distance stored in the internal memory A280 and an angle formed by the optical axes of the optical system A110(a) and the optical system A110(b). The reference picture setting unit A102 then outputs the determined information (hereinafter, will be referred to as reference picture setting information) to the encoding unit 103. Specific operations in the reference picture setting unit A102 will be described later.

Operations of the encoding unit 103 are similar to those of the first embodiment and thus the explanation thereof is omitted.

An example of processing performed by the reference picture setting unit A102 will be described below. The flowchart of processing performed by the reference picture setting unit A102 is identical to those in FIGS. 3 and 7 of the first embodiment except for a method of deciding whether a parallax is large or not. In the second embodiment, for example, whether a parallax is large or not is decided depending upon (1) whether or not an angle formed by the optical axes of the optical system A110(a) and the optical system A110(b) is at least a predetermined third threshold value and (2) whether or not a subject distance is set at a predetermined fourth threshold value or less. Any other methods may be used as long as it is decided whether the first viewpoint video signal and the second viewpoint video signal have many large-parallax areas or not.

As has been discussed, the three-dimensional video capturing apparatus A000 according to the second embodiment sets a reference picture based on distance information obtained in the distance measuring unit A300 or an angle formed by the optical axes of the two optical systems. Hence, unlike in the first embodiment, a reference picture can be set without detecting parallax information from the first viewpoint video signal and the second viewpoint video signal.

As has been discussed, in the three-dimensional video encoding apparatuses of the first and second embodiments, the method of selecting a reference picture or the method of selecting the allocation of a reference index is changed by deciding whether parallax information based on a parallax between the first viewpoint video signal and the second viewpoint video signal is large or not according to the parallax information calculated by the parallax acquisition unit 101 or the shooting condition parameters, enabling encoding according to the characteristics of input image data. Thus, the encoding efficiency of the input image data can be improved, achieving higher encoding efficiency for the three-dimensional video encoding apparatus and higher image quality for a stream encoded using the three-dimensional video encoding apparatus.

The present invention is not limited to the foregoing first and second embodiments.

In the first embodiment, the setting and allocation of a reference index in the encoding of input image data are determined by, for example, deciding whether a parallax is large or not based on parallax information. In the second embodiment, whether a parallax is large or not is decided by the shooting parameters. The parallax information and the shooting parameters may be combined to decide whether a parallax is large or not.

In the first embodiment, a reference picture is set only by deciding whether parallax information on variations in parallax is large or not. For example, a reference picture may be determined by additional information on whether a shooting scene contains a large motion.

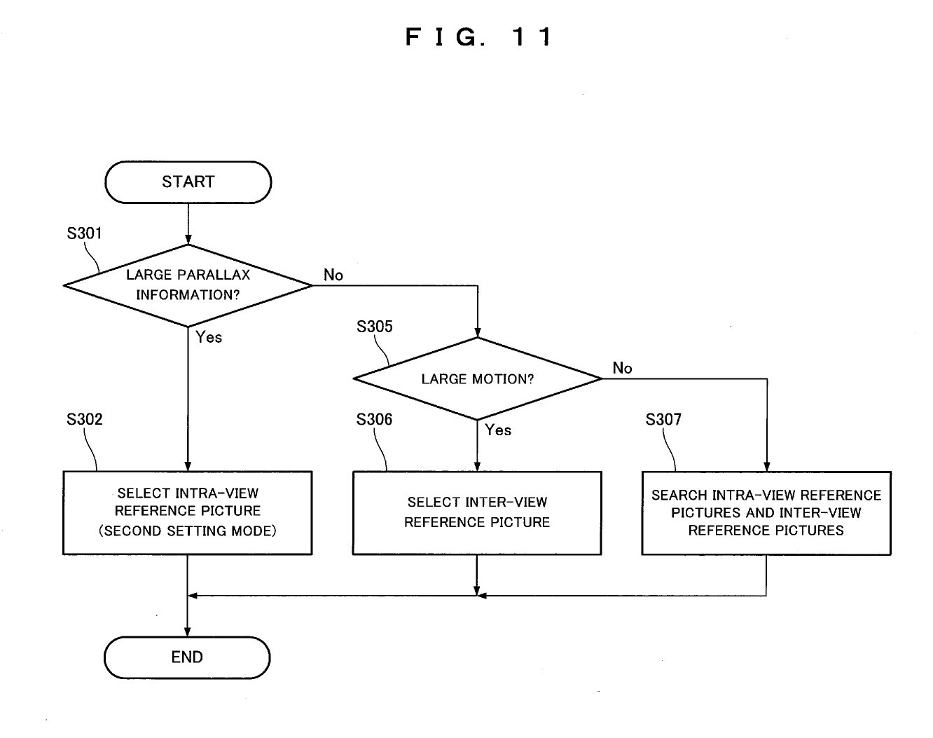

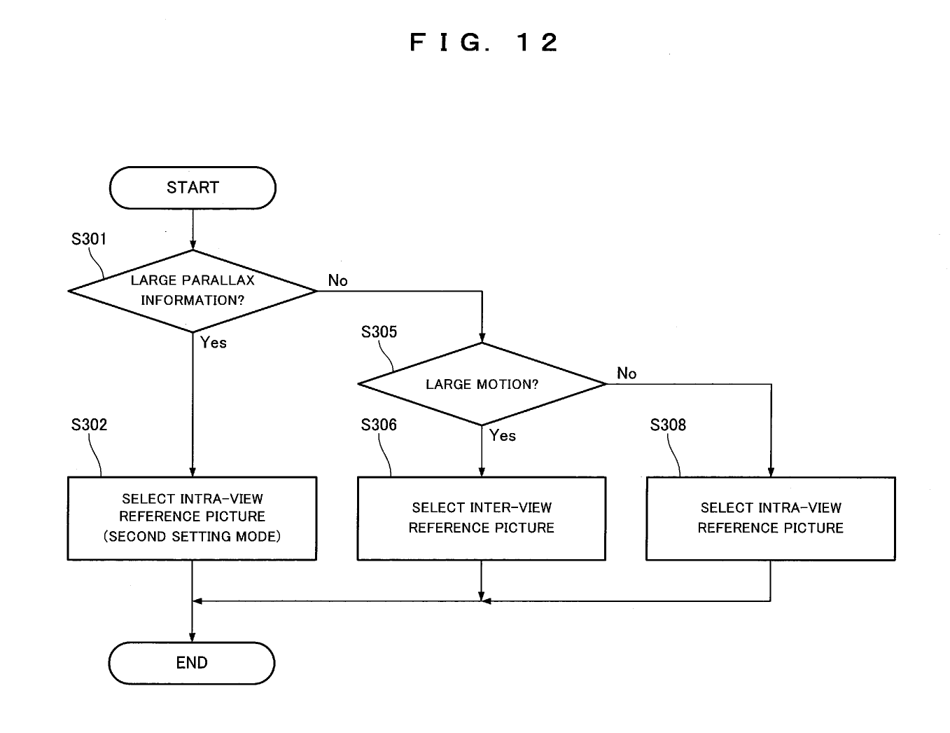

FIGS. 11 and 12 are flowcharts of another modification of a setting operation performed by the reference picture setting unit of the three-dimensional video capturing apparatus according to the first embodiment. When the second viewpoint video signal is encoded, as in FIG. 3, it is decided whether parallax information (including variations in parallax vector) on a parallax between the first viewpoint video signal and the second viewpoint video signal is large or not based on the parallax information inputted from the parallax acquisition unit 101 (step S301). Moreover, as in FIG. 3, in the case where it is decided that the parallax information is large (Yes in step S301), the reference picture setting unit 102 selects a reference picture from intra-view reference pictures included in the second viewpoint video signal (step S302: second setting mode).

In step S301, in the case where it is decided that the parallax information is not large (No in step S301), the process advances from step S301 to step S305 to decide whether a motion in a shooting scene (the first viewpoint video signal or the second viewpoint video signal) is large or not. In the case of a large motion, the process advances to step S306 to select a reference picture from intra-view reference pictures included in the first viewpoint video signal. In the case where it is decided in step S305 that a motion in the shooting scene is not large, the process advances to step S307 to select a reference picture from inter-view reference pictures included in the first viewpoint video signal and inter-view reference pictures included in the second viewpoint video signal (see FIG. 11). As shown in FIG. 12, in the case where it is decided in step S305 that a motion in the shooting scene is not large, the process may advance to step S308 to select a reference picture from intra-view reference pictures included in the second viewpoint video signal.

Moreover, whether a motion in a shooting scene is large or not may be decided by determining a mean value from the results of motion vectors of images in a preceding frame by statistical processing. Alternatively, an image may be in advance reduced in size by preprocessing to have a smaller amount of information, motion vectors may be detected from the image reduced in size, and then a mean value may be determined from the results of the motion vectors by statistical processing. The method of decision is not particularly limited.

According to these method, in the case where it is decided that parallax information indicating variations in parallax vector is large, the first viewpoint video signal, which is a video signal of a first viewpoint where an occlusion area is expanded, is not selected as a reference picture, thereby improving the accuracy of determining a motion vector with higher encoding efficiency. Moreover, according to these methods, in the case of a large motion, an intra-view reference picture included in the second viewpoint video signal is not selected, parallax information indicating variations in parallax vector is not large, and an inter-view reference picture included in the first viewpoint video signal with a small motion is selected, thereby further improving the encoding efficiency of input image data.

In the first and second embodiments, a picture to be encoded is a P picture. Also in the case of a B picture, adaptive switching in the same way can achieve higher encoding efficiency.

In the first and second embodiments, a picture to be encoded is encoded in a frame structure. Also in the case of encoding in a field structure or adaptive switching between a frame structure and a field structure, the encoding efficiency can be improved by adaptively switching the structures in the same way.

In the first and second embodiments, H.264 is used as a compression encoding format. The method is not particularly limited. For example, the present invention may be applied to a compression encoding method capable of setting a reference picture from a plurality of pictures, particularly a compression encoding method having the function of managing reference pictures by allocating reference indexes.

The present invention is not limited to the three-dimensional video encoding apparatuses provided with the constituent elements of the first and second embodiments. For example, the present invention may be applied as a three-dimensional video encoding method including the steps of using the constituent elements of the three-dimensional video encoding apparatus, a three-dimensional video encoding integrated circuit provided with the constituent elements of the three-dimensional video encoding apparatus, and a three-dimensional video encoding program capable of implementing the three-dimensional video encoding method.

The three-dimensional video encoding program can be distributed through recording media such as a compact disc-read only memory (CD-ROM) and communication networks such as the Internet.

The three-dimensional video encoding integrated circuit can be realized as an LSI, a typical integrated circuit. In this case, the LSI may contain a single chip or multiple chips. For example, a functional block other than a memory may contain a single-chip LSI. The LSI may be called an IC, a system LSI, a super LSI, or an ultra LSI.

The technique of circuit integration is not limited to LSIs. The technique may be realized by a dedicated circuit or a general purpose processor or may use a field programmable gate array (FPGA) capable of programming after the manufacturing of an LSI or a reconfigurable processor capable of reconfiguring the connection or setting of a circuit cell in an LSI.

A technique of circuit integration replacing LSIs according to the progress of semiconductor technology or another derivative technique may be naturally used to integrate functional blocks. For example, biotechnology may be adapted.

In circuit integration, only a data storage unit may be separately configured out of functional blocks without being configured as a single chip.

### INDUSTRIAL APPLICABILITY

The three-dimensional video encoding apparatus according to the present invention can achieve video encoding with higher image quality or higher efficiency according to a compression encoding format such as H.264 and thus is applicable to personal computers, HDD recorders, DVD recorders, camera phones, and so on.

What is claimed is:

1. A three-dimensional video encoding apparatus that encodes a first viewpoint video signal that is a video signal of a first viewpoint and a second viewpoint video signal that is a video signal of a second viewpoint different from the first viewpoint,
the three-dimensional video encoding apparatus comprising:
a parallax acquisition unit that obtains parallax information on a parallax between the first viewpoint video signal and the second viewpoint video signal;
a reference picture setting unit that sets a reference picture used for encoding the first viewpoint video signal and the second viewpoint video signal; and
an encoding unit that encodes the first viewpoint video signal and the second viewpoint video signal to generate an encoded stream based on the reference picture set in the reference picture setting unit,
wherein when the second viewpoint video signal is encoded, the reference picture setting unit has a first setting mode of setting, as a reference picture, at least one of pictures included in the first viewpoint video signal and pictures included in the second viewpoint video signal, and a second setting mode of setting, as a reference picture, at least one of pictures included only in the second viewpoint video signal, and
the reference picture setting unit switches the first setting mode and the second setting mode in response to a change of the parallax information obtained in the parallax acquisition unit.

2. The three-dimensional video encoding apparatus according to claim 1, wherein the reference picture setting unit sets, as a reference picture, at least one of pictures included only in the first viewpoint video signal when the second viewpoint video signal is encoded in the first setting mode.

3. The three-dimensional video encoding apparatus according to claim 1, wherein the parallax information is information on variations in parallax vector that indicates a parallax between the first viewpoint video signal and the second viewpoint video signal in one of a pixel and a pixel block containing a plurality of pixels, and
the reference picture setting unit switches the first setting mode to the second setting mode when the parallax information is large, whereas the reference picture setting unit switches the second setting mode to the first setting mode when the parallax information is small.

4. The three-dimensional video encoding apparatus according to claim 3, wherein the parallax information is a variance of the parallax vector.

5. The three-dimensional video encoding apparatus according to claim 3, wherein the parallax information is a sum of parallax vector absolute values.

6. The three-dimensional video encoding apparatus according to claim 3, wherein the parallax information is an absolute value of a difference between a maximum parallax and a minimum parallax of the parallax vector.

7. The three-dimensional video encoding apparatus according to claim 1, wherein the reference picture setting unit is capable of setting at least two reference pictures, and the parallax information is switched so as to change a reference index of the reference picture.

8. The three-dimensional video encoding apparatus according to claim 7, wherein in the case where it is decided that the parallax information is large, the reference picture setting unit is capable of allocating a reference index not larger than a currently allocated reference index to the reference picture included in the second viewpoint video signal, and
in the case where it is decided that the parallax information is not large, the reference picture setting unit is capable of allocating a reference index not larger than the currently allocated reference index to the reference picture included in the first viewpoint video signal.

9. A three-dimensional video capturing apparatus that captures an image of a subject from a first viewpoint and a second viewpoint different from the first viewpoint, and captures an image of a first viewpoint video signal that is a video signal of the first viewpoint and an image of a second viewpoint video signal that is a video signal of the second viewpoint,
the three-dimensional video capturing apparatus comprising:
a video capturing unit that forms an optical image of the subject, captures the optical image, and obtains the first viewpoint video signal and the second viewpoint video signal as digital signals;
a parallax acquisition unit that calculates parallax information on a parallax between the first viewpoint video signal and the second viewpoint video signal;
a reference picture setting unit that sets a reference picture used for encoding the first viewpoint video signal and the second viewpoint video signal;
an encoding unit that encodes the first viewpoint video signal and the second viewpoint video signal to generate an encoded stream based on the reference picture set in the reference picture setting unit;
a recording medium for recording of an output result from the encoding unit; and
a setting unit that sets a shooting condition parameter in the video capturing unit,
wherein when the second viewpoint video signal is encoded, the reference picture setting unit has a first setting mode of setting, as a reference picture, at least one of pictures included in the first viewpoint video signal and pictures included in the second viewpoint video signal, and a second setting mode of setting, as a reference picture, at least one of pictures included only in the second viewpoint video signal, and
the reference picture setting unit switches the first setting mode and the second setting mode in response to one of the shooting condition parameter and a change of the parallax information.

10. The three-dimensional video capturing apparatus according to claim 9, wherein the shooting condition parameter is an angle formed by a shooting direction of the first viewpoint and a shooting direction of the second viewpoint.

11. The three-dimensional video capturing apparatus according to claim 9, wherein the shooting condition parameter is a distance between one of the first viewpoint and the second viewpoint and the subject.

12. The three-dimensional video capturing apparatus according to claim 9, further comprising a motion information decision unit that decides whether an image of a video signal contains a large motion or not,
wherein a reference picture selected in the first setting mode is switchable according to motion information.

13. The three-dimensional video capturing apparatus according to claim 12, wherein in the case where the motion information decision unit decides that a motion is large, a picture included in the first viewpoint video signal is set as a reference picture.

14. A three-dimensional video encoding method of encoding a first viewpoint video signal that is a video signal of a first viewpoint and a second viewpoint video signal that is a video signal of a second viewpoint different from the first viewpoint,
wherein when a reference picture used for encoding the second viewpoint video signal is selected from pictures included in the first viewpoint video signal and pictures included in the second viewpoint video signal,
the method includes the step of changing the reference picture in response to a change of calculated parallax information.
